(19) United States
(12) Patent Application Publication
(10) Pub. No.: US 2026/0276078 A1
(43) Pub. Date: Sep. 17, 2026

(54) DIFFERENTIAL DEVICE FOR VEHICLE

(71) Applicant: JTEKT CORPORATION, Kariya-shi (JP)

(72) Inventor: Makoto NISHIJI, Kariya-shi (JP)

(73) Assignee: JTEKT CORPORATION, Kariya-shi (JP)

(21) Appl. No.: 19/472,806

(22) PCT Filed: Apr. 10, 2023
(86) PCT No.: PCT/JP2023/014569

§ 371 Date: Oct. 6, 2025

(51) Int. Cl. F16H 57/08; F16H 48/10

(52) U.S. Cl. CPC F16H 57/082; F16H 48/10

(57) ABSTRACT

A differential device includes a planetary gear mechanism including plural planetary gears and a carrier, and a differential gear mechanism including a pair of side gears and plural pinion gear sets. In each planetary gear, a one-side supported part and an another-side supported part are supported by the carrier. In each pinion gear set, a first pinion gear that engages with one side gear and a second pinion gear that engages with the another side gear are engaged in a holding hole of the carrier. The carrier includes a carrier main body in which the holding holes are formed, and a carrier lid body that closes one end in an axial direction of the holding holes. The carrier main body includes plural one-side support parts that support the one-side supported parts of the planetary gears, and plural another-side support parts that support the another-side supported parts.

### TECHNICAL FIELD

The present invention relates to a vehicle differential device that is mounted on a vehicle having an electric motor as a driving source and that distributes the driving force input from the electric motor to a pair of side gears and outputs the driving force.

### BACKGROUND ART

In recent years, electrified vehicles having an electric motor as a driving source have been becoming increasingly widespread. As described in, for example, Patent Literatures 1 and 2, some of these electrified vehicles are equipped with a differential device that includes a planetary gear mechanism for reducing the output rotational speed of the electric motor and a differential gear mechanism for distributing the driving force amplified by the planetary gear mechanism to right and left wheels. The differential gear mechanism includes a pair of right and left output gears, and right and left axles are respectively connected to these output gears.

The applicant has proposed the differential device disclosed in Patent Literature 3 as a differential device for distributing the driving force from a driving source such as an engine to drive shafts respectively connected to right and left wheels, while allowing differential motion.

### CITATION LIST

### Patent Literature

Patent Literature 1: JP 2021-110374 A
Patent Literature 2: JP 2016-95034 A
Patent Literature 3: JP 2019-007505 A

### SUMMARY OF INVENTION

### Technical Problem

A differential device mounted on an electrified vehicle is strongly desired to be small and lightweight while ensuring desired strength, in order to secure space for installing components such as a battery and to improve energy efficiency. An object of the present invention is to provide a small and lightweight vehicle differential device.

### Solution to Problem

In order to achieve the above object, the present invention provides a vehicle differential device that includes a pair of side gears disposed coaxially and rotatable relative to each other, and that is configured to distribute a driving force input from an electric motor to the pair of side gears and output the driving force. The vehicle differential device includes: a planetary gear mechanism including a sun gear to which the driving force is input, a plurality of planetary gears that meshes with the sun gear, a carrier that rotatably supports the plurality of planetary gears, and a ring gear that meshes with the plurality of planetary gears at the outer periphery of the carrier; and a plurality of pinion gear sets each including a first pinion gear that meshes with one side gear of the pair of side gears, and a second pinion gear that meshes with the other side gear of the pair of side gears, the first pinion gear and the second pinion gear meshing with each other. In each of the plurality of planetary gears, a plurality of supported portions provided at positions spaced apart in an axial direction is supported by the carrier. The carrier includes: a carrier body having a holding hole that holds the first pinion gear and the second pinion gear such that each of the first pinion gear and the second pinion gear is rotatable about an axis of rotation parallel to a rotational axis of the carrier; and a carrier cover that is disposed alongside the carrier body in the axial direction and closes one axial end of the holding hole. The carrier body is provided with a support portion that supports at least one of the plurality of supported portions of the plurality of planetary gears.

### Advantageous Effects of Invention

The present invention can provide a small and lightweight differential device.

### BRIEF DESCRIPTION OF DRAWINGS

FIG. 1 is a configuration diagram schematically showing an example of the general configuration of a four-wheel drive vehicle according to an embodiment of the present invention.

FIG. 2 is a schematic diagram showing the configuration of a front-wheel drive device.

FIG. 3 is a perspective view of a plurality of planetary gears and a carrier.

FIG. 4 is an exploded perspective view of a differential device.

FIG. 5 is a sectional view taken along line A-A in FIG. 3.

FIG. 6 is a perspective view showing one pinion gear set.

FIG. 7 is a side view showing a first pinion gear.

FIG. 8 is a perspective sectional view of a carrier body.

FIG. 9 is a cross-sectional view taken along line B-B in FIG. 5.

FIG. 10 is a cross-sectional view taken along line C-C in FIG. 5.

FIG. 11 is an external view showing an end of a carrier body.

FIG. 12 is a cross-sectional view of the carrier body perpendicular to an axial direction.

### DESCRIPTION OF EMBODIMENTS

### Embodiment

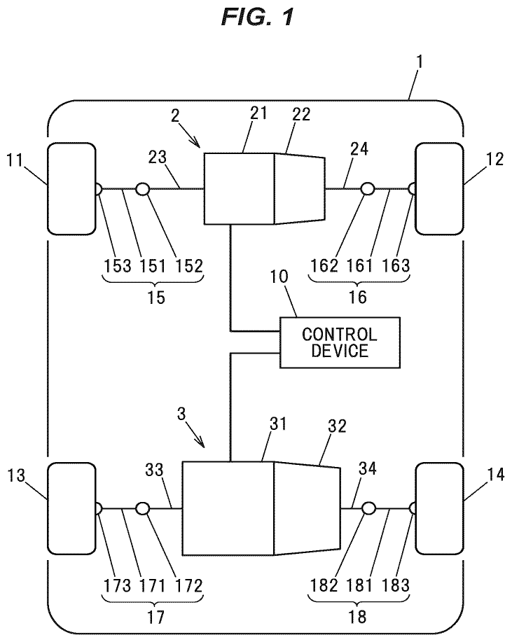

An embodiment of the present invention will be described with reference to FIGS. 1 to 12. The embodiment described below is shown as a suitable specific example for carrying out the present invention, and part of the embodiment specifically illustrates various technically preferable technical matters. However, the technical scope of the present invention is not limited to such specific aspects.

FIG. 1 is a configuration diagram schematically showing an example of the general configuration of a four-wheel drive vehicle 1 according to the embodiment of the present invention. The four-wheel drive vehicle 1 includes: a front-wheel drive device 2 that drives a left front wheel 11 and a right front wheel 12; a rear-wheel drive device 3 that drives a left rear wheel 13 and a right rear wheel 14; and a control device 10 that controls the front-wheel and rear-wheel drive devices 2, 3.

The front-wheel drive device 2 includes an electric motor 21, a differential device 22, and left and right axles 23, 24. The differential device 22 distributes the driving force of the electric motor 21 to the left and right axles 23, 24. The left axle 23 and the left front wheel 11 are connected by a left drive shaft 15, and the right axle 24 and the right front wheel 12 are connected by a right drive shaft 16. The left drive shaft 15 includes an intermediate shaft 151 and constant velocity joints 152, 153 attached to both ends of the intermediate shaft 151. The right drive shaft 16 includes an intermediate shaft 161 and constant velocity joints 162, 163 attached to both ends of the intermediate shaft 161.

The rear-wheel drive device 3 includes an electric motor 31, a differential device 32, and left and right axles 33, 34. The differential device 32 distributes the driving force of the electric motor 31 to the left and right axles 33, 34. The left axle 33 and the left rear wheel 13 are connected by a left drive shaft 17, and the right axle 34 and the right rear wheel 14 are connected by a right drive shaft 18. The left drive shaft 17 includes an intermediate shaft 171 and constant velocity joints 172, 173 attached to both ends of the intermediate shaft 171. The right drive shaft 18 includes an intermediate shaft 181 and constant velocity joints 182, 183 attached to both ends of the intermediate shaft 181.

The control device 10 is configured to acquire information on detection results from various in-vehicle sensors mounted on the four-wheel drive vehicle 1 via an in-vehicle network such as CAN (Control Area Network). The in-vehicle sensors include wheel speed sensors that detect the wheel speeds, namely the rotational speeds of the left front wheel 11, the right front wheel 12, the left rear wheel 13, and the right rear wheel 14, a steering angle sensor that detects a steering angle of a steering wheel operated by the driver, and an accelerator pedal sensor that detects an amount of depression of an accelerator pedal. Based on the above information, the control device 10 controls the electric motor 21 of the front-wheel drive device 2 by supplying a motor current to the electric motor 21, and also controls the electric motor 31 of the rear-wheel drive device 3 by supplying a motor current to the electric motor 31.

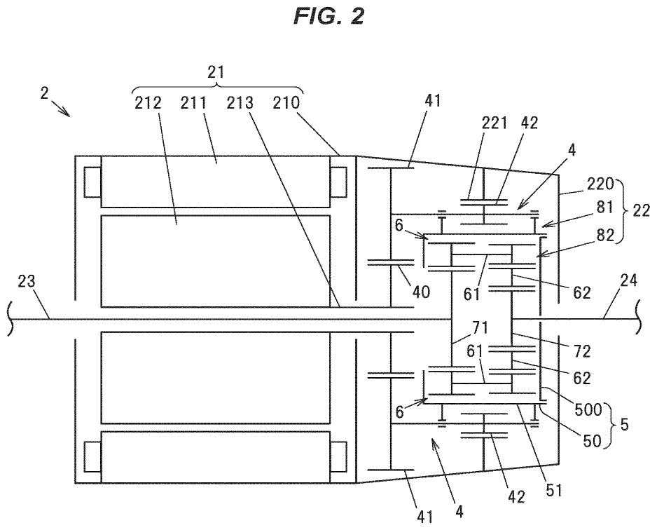

FIG. 2 is a schematic diagram showing the configuration of the front-wheel drive device 2. The rear-wheel drive device 3 is configured in the same manner as that of the front-wheel drive device 2.

The electric motor 21 includes a motor case 210, a stator 211 fixed to the motor case 210, a rotor 212 that rotates relative to the stator 211, and a tubular motor shaft 213 that rotates with the rotor 212. The stator 211 generates a magnetic field by a motor current supplied from the control device 10, and a permanent magnet of the rotor 212 generates torque due to this magnetic field. The torque generated in the rotor 212 is output from the motor shaft 213 to the differential device 22 as a driving force for driving the left front wheel 11 and the right front wheel 12.

The differential device 22 includes: a housing 220 fixed to the motor case 210; a sun gear 40 fixed to the motor shaft 213; a plurality of planetary gears 4; a carrier 5 that rotatably supports the plurality of planetary gears 4; a ring gear 221 fixed to the housing 220; a plurality of pinion gear sets 6 each configured by meshing a first pinion gear 61 with a second pinion gear 62; and a pair of left and right side gears 71, 72.

The plurality of planetary gears 4, the carrier 5, and the ring gear 221 constitute a planetary gear mechanism 81 that functions as a speed reducer for reducing the output rotational speed of the electric motor 21. The plurality of pinion gear sets 6 and the first and second side gears 71, 72 constitute a differential gear mechanism 82 that distributes the driving force of the electric motor 21, amplified by the planetary gear mechanism 81, to the left and right axles 23, 24 while allowing differential motion. That is, the differential device 22 of the present embodiment is a differential device with a speed reducer, having the planetary gear mechanism 81 as a speed reducer for reducing the output rotational speed of the electric motor 21.

The housing 220 accommodates the plurality of planetary gears 4 and the carrier 5. Lubricating oil for lubricating components of the differential device 22 is sealed in the housing 220. The planetary gear 4 includes a plurality of supported portions provided at positions spaced apart in the axial direction, and the plurality of supported portions is supported by the carrier 5. The carrier 5 includes a plurality of support portions that supports the plurality of supported portions of each planetary gear 4.

The motor shaft 213 of the electric motor 21, the carrier 5, and the side gears 71, 72 are arranged side by side in the vehicle width direction of the four-wheel drive vehicle 1 and coaxially so as to be rotatable relative to each other. The ring gear 221 is disposed around the outer periphery of the carrier 5. The left axle 23 is inserted through the center of the motor shaft 213 of the electric motor 21. The left axle 23 is longer than the right axle 24 by the length of the motor shaft 213.

The left axle 23 is connected to the left side gear 71 so as not to be rotatable relative to the left side gear 71. The right axle 24 is connected to the right side gear 72 so as not to be rotatable relative to the right side gear 72. Hereinafter, of the side gears 71, 72, the left side gear 71 will be referred to as first side gear 71, and the right side gear 72 will be referred to as second side gear 72. The first side gear 71 is formed to have a larger diameter than the second side gear 72.

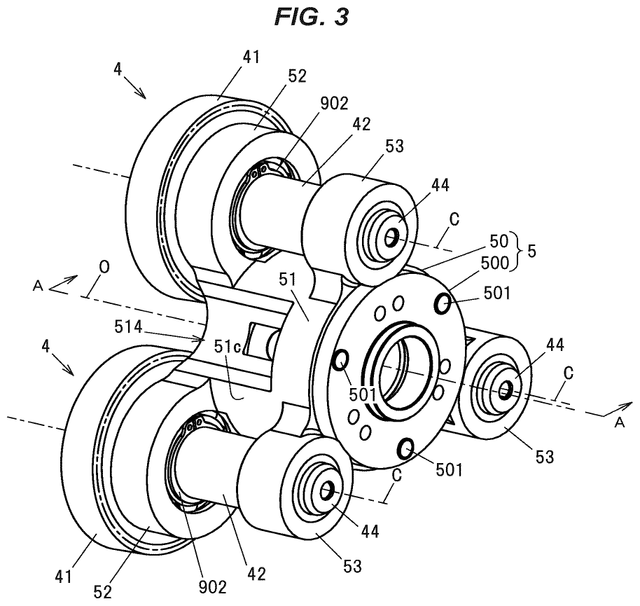

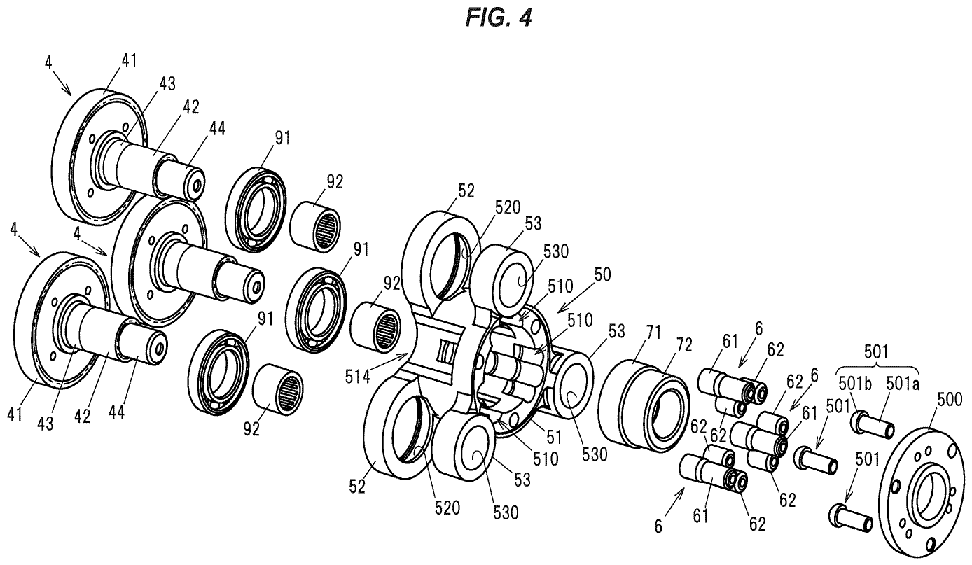

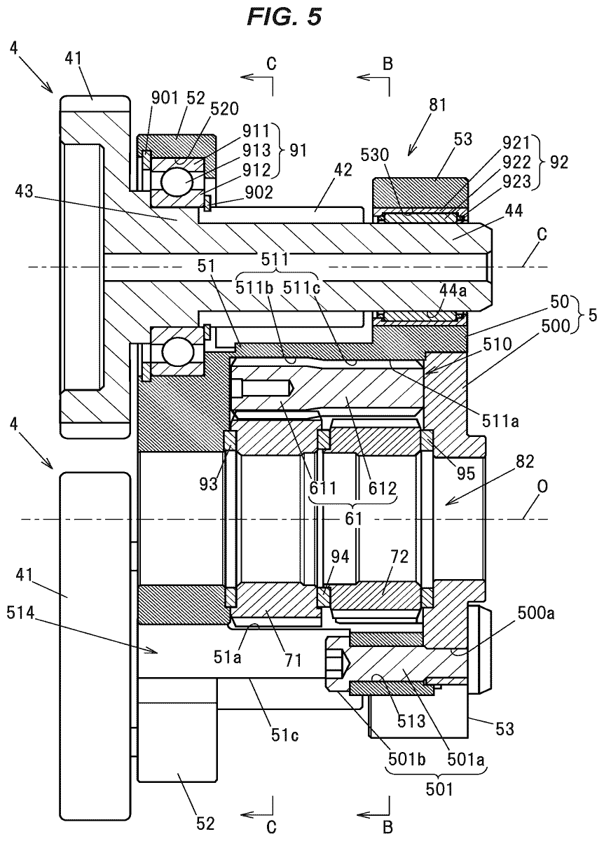

FIG. 3 is a perspective view showing the plurality of planetary gears 4 and the carrier 5. FIG. 4 is an exploded perspective view of the differential device 22, showing the plurality of planetary gears 4, the carrier 5, the plurality of pinion gear sets 6, the first and second side gears 71, 72, etc. FIG. 5 is a sectional view taken along line A-A in FIG. 3. In FIGS. 3 and 5, the rotational axis O of the carrier 5 and the central axis C of each of the plurality of planetary gears 4 are indicated by long dashed short dashed lines. The rotational axis O of the carrier 5 and the central axis C of each of the plurality of planetary gears 4 are parallel to each other.

The planetary gear mechanism 81 includes three planetary gears 4 that are arranged at equal intervals along the circumferential direction of the carrier 5. Each planetary gear 4 has a large-diameter gear portion 41 and a small-diameter gear portion 42 that are disposed coaxially and have different pitch circle diameters. The large-diameter gear portion 41 meshes with the sun gear 40, and the small-diameter gear portion 42 meshes with the ring gear 221 at the outer periphery of the carrier 5. The pitch circle diameter of the large-diameter gear portion 41 is, for example, at least twice the pitch circle diameter of the small-diameter gear portion 42.

When the sun gear 40 rotates with the motor shaft 213, the large-diameter gear portion 41 and the small-diameter gear portion 42 of each of the plurality of planetary gears 4 rotate together about the central axis C. The large-diameter gear portion 41 and the small-diameter gear portion 42 are helical gears each having, on its outer peripheral surface, a plurality of helical teeth whose tooth traces are inclined with respect to the axial direction. In FIGS. 3 to 5, illustration of the helical teeth is omitted, and the large-diameter gear portion 41 and the small-diameter gear portion 42 are shown in a simplified manner.

The planetary gear 4 includes, as the plurality of supported portions supported by the carrier 5, a one-side supported portion 43 and another-side supported portion 44 that are coaxial with the large-diameter gear portion 41 and the small-diameter gear portion 42. The one-side supported portion 43 is supported by the carrier 5 on one axial side of the small-diameter gear portion 42 that is the side closer to the large-diameter gear portion 41. The other-side supported portion 44 is supported by the carrier 5 on the other axial side of the small-diameter gear portion 42. In the present embodiment, the one-side supported portion 43 is provided between the large-diameter gear portion 41 and the small-diameter gear portion 42. The other-side supported portion 44 is provided at the opposite end of the planetary gear 4 from the large-diameter gear portion 41.

The carrier 5 includes a carrier body 50 and a carrier cover 500, and the carrier cover 500 is fixed to the carrier body 50 with a plurality of bolts 501. The carrier body 50 is provided with a support portion that supports at least one of the plurality of supported portions (the one-side supported portion 43 and the other-side supported portion 44) of the planetary gear 4. In the present embodiment, the carrier body 50 integrally includes: a cylindrical pinion gear holding portion 51; a plurality of one-side support portions 52 each supporting the one-side supported portion 43 of a corresponding one of the planetary gears 4; and a plurality of other-side support portions 53 each supporting the other-side supported portion 44 of a corresponding one of the planetary gears 4.

The plurality of one-side support portions 52 is provided on the outer periphery of the end of the pinion gear holding portion 51 on the side of the large-diameter gear portions 41 of the planetary gears 4, so as to protrude in a radial direction perpendicular to the rotational axis O. The plurality of other-side support portions 53 is provided on the outer periphery of the opposite end of the pinion gear holding portion 51 from the large-diameter gear portions 41 of the planetary gears 4, so as to protrude in a radial direction perpendicular to the rotational axis O.

The plurality of one-side support portions 52 each support the one-side supported portion 43 of a corresponding one of the planetary gears 4 via a corresponding one of first bearings 91. The first bearing 91 is a ball bearing in which a plurality of rolling elements (balls) 913 is arranged between an outer ring 911 and an inner ring 912, and is accommodated in a housing bore 520 formed in the one-side support portion 52. The outer ring 911 is restricted from moving in the axial direction by a snap ring 901 fitted in the one-side support portion 52. The inner ring 912 is restricted from moving in the axial direction relative to the planetary gear 4 by a snap ring 902 fitted on the planetary gear 4.

The plurality of other-side support portions 53 each support the other-side supported portion 44 of a corresponding one of the planetary gears 4 via a corresponding one of second bearings 92. The second bearing 92 is a needle roller bearing in which a plurality of needle rollers 922 is arranged inside a cylindrical outer ring 921, and is accommodated in a housing bore 530 formed in the other-side support portion 53. The plurality of needle rollers 922 is retained by a cage 923 and roll on an outer peripheral surface 44a of the other-side supported portion 44.

The carrier cover 500 is disposed alongside the carrier body 50 in the axial direction, and is fixed to one of two ends of the carrier body 50 on the side where the plurality of other-side support portions 53 is provided. The first side gear 71 is disposed at a position closer to the large-diameter gear portions 41 of the planetary gears 4 than the second side gear 72. The second side gear 72 is disposed on the side closer to the plurality of other-side support portions 53 than to the plurality of one-side support portions 52. In the present embodiment, an axial portion of the second side gear 72 is disposed inward of the plurality of other-side support portions 53 in a radial direction perpendicular to the rotational axis O.

A portion of the pinion gear holding portion 51 is aligned with the first side gear 71 in the axial direction, and a first side washer 93 is disposed between the first side gear 71 and the pinion gear holding portion 51. A center washer 94 is disposed between the first side gear 71 and the second side gear 72. A second side washer 95 is disposed between the second side gear 72 and the carrier cover 500.

The first pinion gear 61 meshes with the first side gear 71. The second pinion gear 62 is disposed on the outer periphery of the second side gear 72, and meshes with the first pinion gear 61 and the second side gear 72. In the present embodiment, each of the plurality of pinion gear sets 6 includes one first pinion gear 61 and two second pinion gears 62, and the first pinion gear 61 is disposed between the two second pinion gears 62. The number of pinion gear sets 6 in the differential device 22 is the same as the number of planetary gears 4. In the present embodiment, three pinion gear sets 6 are held by the pinion gear holding portion 51 of the carrier 5.

The first and second pinion gears 61, 62 and the first and second side gears 71, 72 are helical gears each having, on its outer peripheral surface, a plurality of helical teeth whose tooth traces are inclined with respect to the axial direction. In FIGS. 3 to 5, illustration of the helical teeth is omitted, and each gear is shown in a simplified manner. A plurality of holding holes 510, each for holding the first pinion gear 61 and the two second pinion gears 62 of a corresponding one of the pinion gear sets 6, is formed in the pinion gear holding portion 51 of the carrier body 50.

The plurality of holding holes 510 is formed between the plurality of one-side support portions 52 and the plurality of other-side support portions 53 in the axial direction parallel to the rotational axis O. An axial portion of each of the plurality of holding holes 510 is formed inward of a corresponding one of the plurality of other-side support portions 53 in a radial direction perpendicular to the rotational axis O.

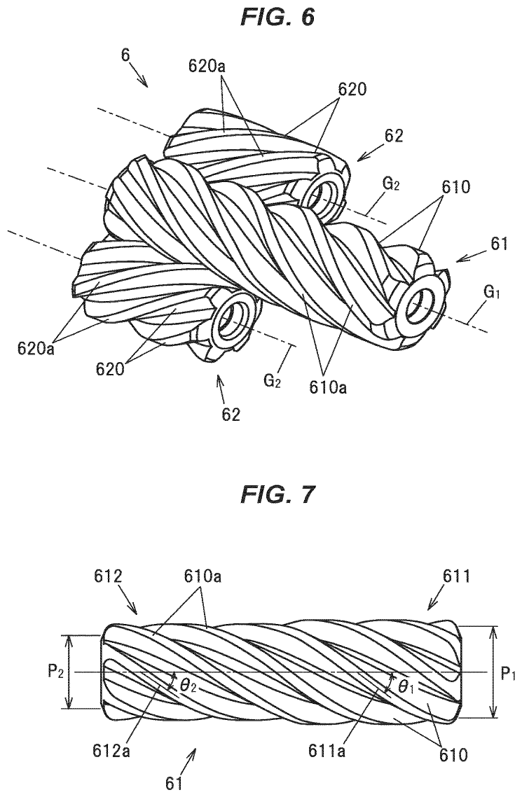

FIG. 6 is a perspective view showing one pinion gear set 6. FIG. 7 is a side view showing the first pinion gear 61. In the example shown in FIGS. 6 and 7, six helical teeth 610 are formed on the first pinion gear 61, and the same number of helical teeth 620 are formed on each second pinion gear 62. Tooth tip surfaces 610a, 620a of the helical teeth 610, 620 are formed with a predetermined width in a direction perpendicular to the tooth trace. The gear axis G₁ of the first pinion gear 61 and the gear axes G₂ of the second pinion gears 62 are parallel to the rotational axis O of the carrier 5.

The second pinion gears 62 are formed shorter in the axial direction than the first pinion gear 61, and mesh with the first pinion gear 61 on the outer peripheral side of the second side gear 72. The axial length of the first pinion gear 61 corresponds to the combined axial widths of the first side gear 71 and the second side gear 72. The axial length of each second pinion gear 62 corresponds to the axial width of the second side gear 72.

In the first pinion gear 61, a large-diameter portion 611 and a small-diameter portion 612 that have different pitch circle diameters are formed side by side in the axial direction. The large-diameter portion 611 meshes with the first side gear 71. The small-diameter portion 612 meshes with the two second pinion gears 62. As shown in FIG. 5, the entire large-diameter portion 611 is disposed between the plurality of one-side support portions 52 and the plurality of other-side support portions 53 in the axial direction parallel to the rotational axis O of the carrier 5. An axial portion of the small-diameter portion 612 is disposed inward of the plurality of other-side support portions 53 in a radial direction perpendicular to the rotational axis O.

When P₁ represents the pitch circle diameter of the large-diameter portion 611 and P₂ represents the pitch circle diameter of the small-diameter portion 612, the ratio of P₁ to P₂ (P₁/P₂) is, for example, from 1.05 to 1.15. When θ₁ represents the helix angle of a tooth trace 611a in the large-diameter portion 611 and θ₂ represents the helix angle of a tooth trace 612a in the small-diameter portion 612, θ₁ is greater than θ₂, and the ratio (θ₁/θ₂) is, for example, the same as the ratio of the pitch circle diameters of the large-diameter portion 611 and the small-diameter portion 612.

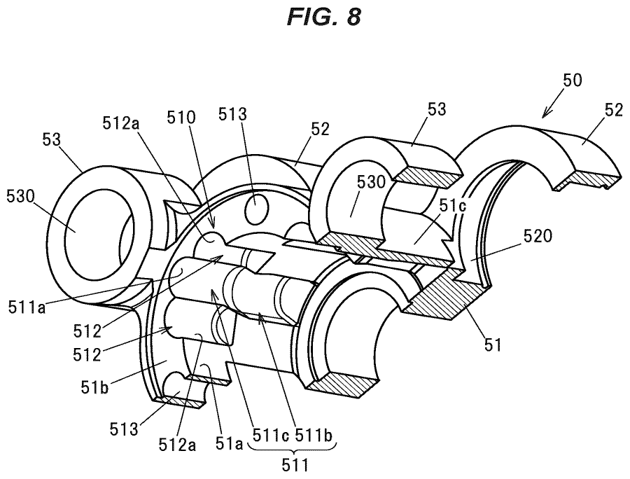

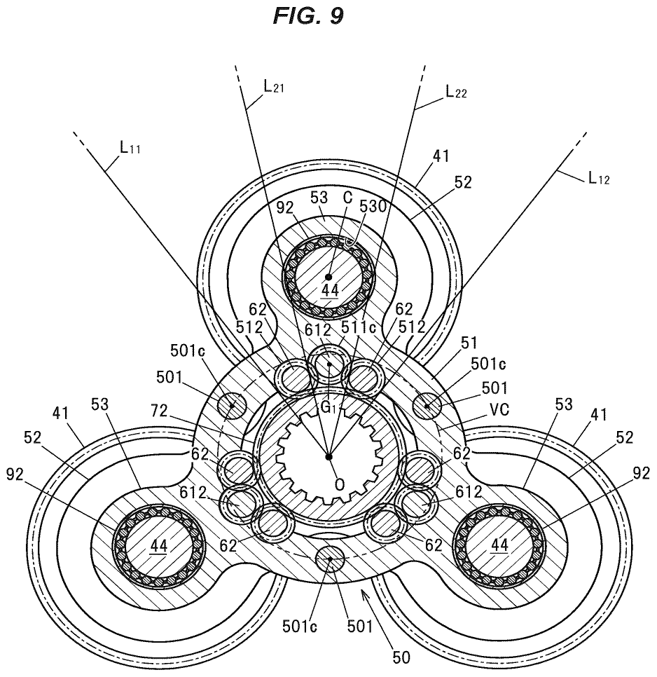

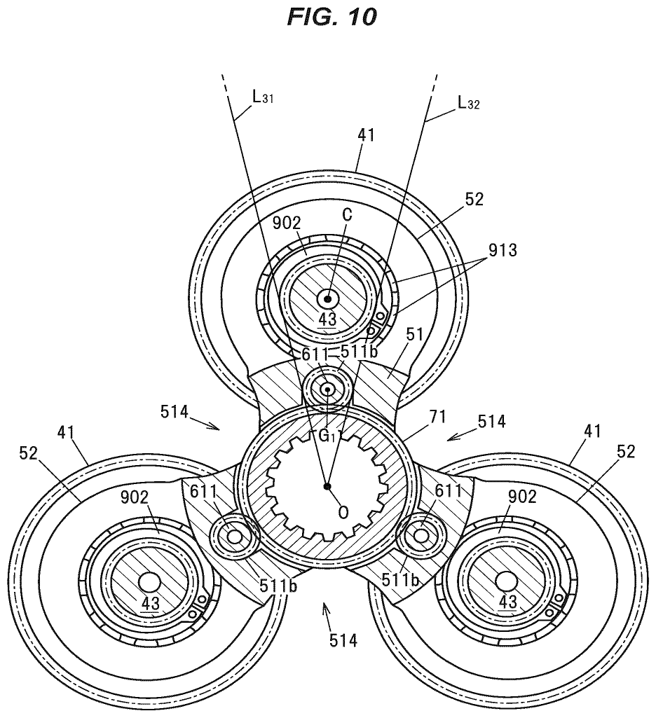

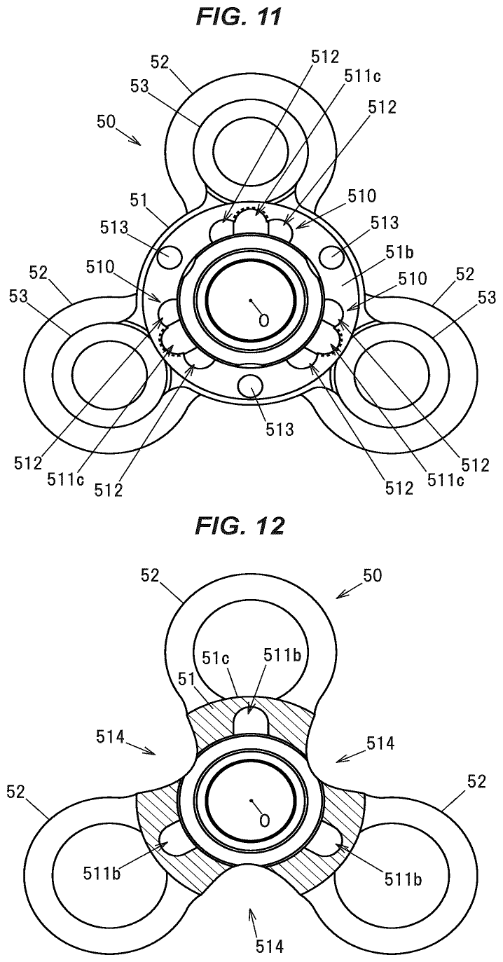

FIG. 8 is a perspective sectional view of the carrier body 50, showing the inside of the pinion gear holding portion 51. FIG. 9 is a cross-sectional view of the differential gear mechanism 82 and the planetary gear mechanism 81 taken along line B-B in FIG. 5. FIG. 10 is a cross-sectional view of the differential gear mechanism 82 and the planetary gear mechanism 81 taken along line C-C in FIG. 5. FIG. 11 is an external view of the end of the carrier body 50 on the side where the other-side support portions 53 are located, as viewed in a direction along the rotational axis O. FIG. 12 is a cross-sectional view of the carrier body 50 taken along line C-C in FIG. 5.

Three holding holes 510 are formed at equal intervals in the circumferential direction in the pinion gear holding portion 51 of the carrier body 50. Each holding hole 510 includes a first hole portion 511 for holding the first pinion gear 61 and two second hole portions 512 each for holding a corresponding one of the two second pinion gears 62. The first hole portion 511 and the two second hole portions 512 communicate with each other. The first pinion gear 61 and the two second pinion gears 62 are accommodated in the holding hole 510 such that each of the first and second pinion gears 61, 62 rotates (spins) about its axis of rotation parallel to the rotational axis O of the carrier 5.

The first hole portion 511 and the second hole portions 512 open to an inner peripheral surface 51a of the pinion gear holding portion 51. A circumferential portion of the first pinion gear 61 protrudes from the first hole portion 511 toward the inside of the pinion gear holding portion 51 and meshes with the first side gear 71. A circumferential portion of the second pinion gear 62 protrudes from the second hole portion 512 toward the inside of the pinion gear holding portion 51 and meshes with the second side gear 72.

The first hole portion 511 and the second hole portions 512 open to an axial end face 51b of the carrier body 50 in the pinion gear holding portion 51. The carrier cover 500 abuts against the axial end face 51b of the pinion gear holding portion 51 by axial forces of the plurality of bolts 501, and closes one axial end of each of the plurality of holding holes 510.

The driving force of the electric motor 21 input to the carrier 5 is transmitted to the first pinion gear 61 and the second pinion gears 62 through contact of the tooth tip surfaces 610a, 620a with an inner surface 511a of the first hole portion 511 and inner surfaces 512a of the second hole portions 512, namely the inner surface of the holding hole 510. The driving force transmitted to the large-diameter portion 611 and the small-diameter portion 612 of the first pinion gear 61 is transmitted from the large-diameter portion 611 to the first side gear 71. The driving force transmitted to the two second pinion gears 62 is transmitted to the second side gear 72.

When a difference in wheel speed occurs between the left front wheel 11 and the right front wheel 12 and the first side gear 71 and the second side gear 72 rotate differentially, the tooth tip surfaces 610a of the plurality of helical teeth 610 of the first pinion gear 61 slide against the inner surface 511a of the first hole portion 511, and the tooth tip surfaces 620a of the plurality of helical teeth 620 of the second pinion gear 62 slide against the inner surface 512a of the second hole portion 512, generating a frictional resistance force.

Due to this frictional resistance force, it becomes less likely that, when the driving force can no longer be transmitted to one of the left front wheel 11 and the right front wheel 12 due to slipping etc., the differential gear mechanism 82 spins freely and the driving force can no longer be transmitted to the other wheel either. That is, the frictional resistance force generated between the inner surface of the holding hole 510 and the tooth tip surfaces 610a, 620a of the first pinion gear 61 and the second pinion gears 62 serves as a differential limiting force for restricting differential motion between the left front wheel 11 and the right front wheel 12.

The first hole portion 511 includes a large-diameter hole portion 511b that holds the large-diameter portion 611 of the first pinion gear 61, and a small-diameter hole portion 511c that holds the small-diameter portion 612 of the second pinion gear 62. The large-diameter hole portion 511b is formed to have a larger diameter than the small-diameter hole portion 511c. In FIG. 11, a portion of each large-diameter hole portion 511b is indicated by a dashed line.

As shown in FIGS. 5, 9, and 10, the positions of the plurality of pinion gear sets 6 in a radial direction perpendicular to the rotational axis O of the carrier 5 are closer to the rotational axis O than the positions of the small-diameter gear portions 42 of the plurality of planetary gears 4 in the radial direction. The plurality of holding holes 510 is formed inward of the plurality of planetary gears 4 in a radial direction perpendicular to the rotational axis O. The entire axial extent of each first hole portion 511 is located radially inward of the small-diameter gear portions 42 and the other-side supported portions 44 of the plurality of planetary gears 4.

As shown in FIG. 9, in a cross-section perpendicular to the rotational axis O, when a pair of rays, each extending from the rotational axis O, with one ray being tangent to one end of the holding hole 510 in the circumferential direction about the rotational axis O and the other ray being tangent to the other end of the holding hole 510, are defined as L₁₁, L₁₂, the central axis C of each of the plurality of planetary gears 4 is located between the corresponding rays L₁₁, L₁₂. When a pair of rays, each extending from the rotational axis O, with one ray being tangent to one end of the small-diameter portion 612 of the first pinion gear 61 in the circumferential direction about the rotational axis O and the other ray being tangent to the other end of the small-diameter portion 612 of the first pinion gear 61, is defined as L₂₁, L₂₂, the central axis C of each of the plurality of planetary gears 4 is located between the corresponding rays L₂₁, L₂₂.

As shown in FIG. 10, in a cross-section perpendicular to the rotational axis O, when a pair of rays, with one ray being tangent to one end of the large-diameter portion 611 of the first pinion gear 61 in the circumferential direction about the rotational axis O and the other ray being tangent to the other end of the large-diameter portion 611 of the first pinion gear 61, is defined as L₃₁, L₃₂, the central axis C of each of the plurality of planetary gears 4 is located between the corresponding rays L₃₁, L₃₂. In the present embodiment, the gear axis G₁ of the first pinion gear 61 of each of the plurality of pinion gear sets 6 is aligned with the central axis C of a corresponding one of the plurality of planetary gears 4 in a radial direction perpendicular to the rotational axis O.

As shown in FIGS. 5, 8, and 11, a plurality of bolt insertion holes 513, each for inserting a corresponding one of the plurality of bolts 501 that fixes the carrier cover 500 to the carrier body 50, is formed in the pinion gear holding portion 51 of the carrier body 50 so as to be parallel to the rotational axis O. The pinion gear holding portion 51 also has a plurality of recesses 514 recessed from its outer peripheral surface 51c toward its inner peripheral surface 51a, with the deepest portion of each recess 514 opening to the inner peripheral surface 51a. The recesses 514 function as oil holes that allow lubricating oil to flow between the inside and outside of the pinion gear holding portion 51. Forming the plurality of recesses 514 reduces the weight of the pinion gear holding portion 51.

The bolt 501 includes a shaft 501a inserted through the bolt insertion hole 513, and a head 501b having a larger diameter than the shaft 501a. The head 501b is disposed within the recess 514. Screw holes 500a into which the distal ends of the shafts 501a having passed through the bolt insertion holes 513 are screwed are formed in the carrier cover 500 so as to extend therethrough in the axial direction.

When the carrier 5 is viewed along the rotational axis O from the carrier cover 500 side, the plurality of bolts 501 is disposed between the plurality of holding holes 510 in the circumferential direction about the rotational axis O. In FIG. 9, an imaginary circle VC centered on the rotational axis O and passing through center points 501c of the plurality of bolts 501 is indicated by a long dashed double-short dashed line. The imaginary circle VC intersects a portion of each of the plurality of holding holes 510.

In the differential device 22 configured as described above, when the sun gear 40 is rotationally driven by the electric motor 21, the plurality of planetary gears 4 revolves around the rotational axis O, which causes the carrier 5 to rotate relative to the housing 220 due to meshing between the small-diameter gear portion 42 of each planetary gear 4 and the ring gear 221. When a difference in wheel speed occurs between the left front wheel 11 and the right front wheel 12 during, for example, turning of the four-wheel drive vehicle 1, the first and second pinion gears 61, 62 rotate within the holding holes 510, thereby distributing the driving force from the first and second side gears 71, 72 to the left and right axles 23, 24 while allowing differential motion. Differential motion between the left and right axles 23, 24 is restricted by the frictional resistance force generated between the tooth tip surfaces 610a, 620a of the first and second pinion gears 61, 62 and the inner surfaces of the holding holes 510.

### Effects of Embodiment

According to the embodiment of the present invention described above, the carrier 5 is constituted by the carrier body 50 in which the plurality of holding holes 510 is formed, and the carrier cover 500 that closes the plurality of holding holes 510. The plurality of first-side support portions 52 and the plurality of other-side support portions 53 are provided in the carrier body 50. Accordingly, compared to a case where the pinion gear holding portion 51 and the plurality of first-side support portions 52 and the plurality of other-side support portions 53 are provided as separate members, the driving force input from the plurality of planetary gears 4 to the plurality of first-side support portions 52 and the plurality of other-side support portions 53 can be directly transmitted to the plurality of pinion gear sets 6, thereby making it possible to reduce the size and weight of the differential device 22 while ensuring the strength of the carrier 5. As long as at least one of the plurality of first-side support portions 52 and the plurality of other-side support portions 53 is provided in the carrier body 50, it is possible to achieve reduction in size and weight of the differential device 22 while ensuring the strength of the carrier 5.

In the present embodiment, the carrier cover 500 is fixed to one of two ends of the carrier body 50 on the side where the plurality of other-side support portions 53 is provided. Accordingly, for example, even with the plurality of planetary gears 4 mounted on the carrier 5, the carrier cover 500 can be attached to and detached from the carrier body 50 without the large-diameter gear portions 41 becoming an obstacle, thereby facilitating assembly. The carrier cover 500 is attached to the axial end face 51b of the carrier body 50 to which both the first hole portion 511 and the second hole portions 512 open. Accordingly, one first pinion gear 61 and two second pinion gears 62 of each pinion gear set 6 can be easily assembled into the pinion gear holding portion 51 of the carrier body 50.

In the present embodiment, the plurality of one-side support portions 52 and the plurality of other-side support portions 53 of the carrier body 50 are provided on the outer periphery of the cylindrical pinion gear holding portion 51 so as to protrude in a radial direction perpendicular to the rotational axis O. Accordingly, a space is formed between the plurality of one-side support portions 52 and the plurality of other-side support portions 53, thereby reducing the weight of the carrier body 50.

In the present embodiment, in a cross-section of the carrier body 50 perpendicular to the rotational axis O, the plurality of bolts 501 is arranged such that the imaginary circle VC passing through the center points 501c of the plurality of bolts 501 intersects the plurality of holding holes 510. Accordingly, the carrier cover 500 can be fixed to the carrier body 50 with the plurality of bolts 501 while reducing an increase in diameter of the pinion gear holding portion 51.

### Additional Notes

Although the present invention is described above based on the embodiment, the embodiment is not intended to limit the invention according to the claims. It should be noted that not all the combinations of features described in the embodiment are essential to means for solving the problem in the invention. The present invention may be modified as appropriate by omitting some components or adding or replacing components without departing from the spirit and scope of the present invention. For example, the present invention may be modified as described below.

The above embodiment illustrates the case where the differential device of the present invention is applied to the four-wheel drive vehicle 1. However, the present invention is not limited to this, and the differential device of the present invention may be applied to a two-wheel drive vehicle that drives only the right and left front wheels or the right and left rear wheels.

The above embodiment illustrates the case where the first side gear 71 is connected to the left axle 23 and the second side gear 72 is connected to the right axle 24. However, this left-right relationship may be reversed.

The above embodiment illustrates the case where the one-side support portion 52 of the carrier 5 supports the planetary gear 4 at a position between the large-diameter gear portion 41 and the small-diameter gear portion 42. However, the present invention is not limited to this, and the one-side support portion 52 may support the planetary gear 4 at one end of the planetary gear 4 that is on the side opposite to the other-side support portion 53. Furthermore, the planetary gear 4 may be formed in a hollow shape with a cavity formed at its center, and the carrier 5 may be provided with a support shaft that is inserted through the center of the planetary gear 4. Bearings that support the planetary gear 4 relative to the support shaft on one axial side and the other axial side of the small-diameter gear portion 42 of the planetary gear 4 may be disposed between the outer peripheral surface of the support shaft and the inner peripheral surface of the cavity of the planetary gear 4. In this case, a portion of the support shaft on the one axial side of the small-diameter gear portion 42 serves as the one-side support portion of the present invention, and a portion of the support shaft on the other axial side of the small-diameter gear portion 42 serves as the other-side support portion of the present invention.

### REFERENCE SIGNS LIST

21 ELECTRIC MOTOR
22 DIFFERENTIAL DEVICE
4 PLANETARY GEAR
41 LARGE-DIAMETER GEAR PORTION
42 SMALL-DIAMETER GEAR PORTION
43 ONE-SIDE SUPPORTED PORTION
44 OTHER-SIDE SUPPORTED PORTION
5 CAREER
50 CARRIER BODY
500 CARRIER COVER
51 PINION GEAR HOLDING PORTION
510 HOLDING HOLE
52 ONE-SIDE SUPPORT PORTION
53 OTHER-SIDE SUPPORT PORTION
6 PINION GEAR SET
61 FIRST PINION GEAR
62 SECOND PINION GEAR
71 FIRST SIDE GEAR
72 SECOND SIDE GEAR
81 PLANETARY GEAR MECHANISM
O ROTATIONAL AXIS
VC IMAGINARY CIRCLE

1-6. (canceled)

7. A vehicle differential device including a pair of side gears disposed coaxially and rotatable relative to each other, the vehicle differential device being configured to distribute a driving force input from an electric motor to the pair of side gears and output the driving force, the vehicle differential device comprising:
a planetary gear mechanism including a sun gear to which the driving force is input, a plurality of planetary gears that meshes with the sun gear, a carrier that rotatably supports the plurality of planetary gears, and a ring gear that meshes with the plurality of planetary gears at an outer periphery of the carrier; and
a plurality of pinion gear sets each including a first pinion gear that meshes with one side gear of the pair of side gears, and a second pinion gear that meshes with the other side gear of the pair of side gears, the first pinion gear and the second pinion gear meshing with each other, wherein:
in each of the plurality of planetary gears, a plurality of supported portions provided at positions spaced apart in an axial direction is supported by the carrier;
the carrier includes a carrier body having a holding hole that holds the first pinion gear and the second pinion gear such that each of the first pinion gear and the second pinion gear is rotatable about an axis of rotation parallel to a rotational axis of the carrier, and a carrier cover that is disposed alongside the carrier body in the axial direction and closes one axial end of the holding hole;
the carrier body is provided with a support portion that supports at least one of the plurality of supported portions of the plurality of planetary gears;
the holding hole includes a first hole portion that holds the first pinion gear and a second hole portion that holds the second pinion gear, the first hole portion and the second hole portion communicating with each other,
the driving force is transmitted from the carrier to the first pinion gear through contact between a tooth tip surface of the first pinion gear and an inner surface of the first hole portion; and
the driving force is transmitted from the carrier to the second pinion gear through contact between a tooth tip surface of the second pinion gear and an inner surface of the second hole portion.

8. The vehicle differential device according to claim 7, wherein:
each of the plurality of planetary gears includes a large-diameter gear portion, a small-diameter gear portion, and the plurality of supported portions that are disposed coaxially, the large-diameter gear portion and the small-diameter gear portion having different pitch circle diameters, the large-diameter gear portion meshing with the sun gear, and the small-diameter gear portion meshing with the ring gear;
the plurality of supported portions includes a one-side supported portion that is supported by the carrier on one axial side of the small-diameter gear portion that is a side closer to the large-diameter gear portion, and another-side supported portion that is supported by the carrier on another axial side of the small-diameter gear portion, and
the carrier body includes a plurality of other-side support portions each supporting the other-side supported portion of a corresponding one of the plurality of planetary gears.

9. The vehicle differential device according to claim 8, wherein the carrier body includes a plurality of one-side support portions each supporting the one-side supported portion of a corresponding one of the plurality of planetary gears.

10. The vehicle differential device according to claim 8, wherein the plurality of other-side support portions of the carrier body is provided on an outer periphery of a cylindrical pinion gear holding portion having a plurality of the holding holes, so as to protrude in a radial direction perpendicular to the rotational axis.

11. The vehicle differential device according to claim 8, wherein the carrier cover is fixed to one of two ends of the carrier body on a side where the plurality of other-side support portions is provided.

12. The vehicle differential device according to claim 7, wherein:
the carrier cover is fixed to the carrier body with a plurality of bolts; and
in a cross-section perpendicular to the rotational axis, an imaginary circle centered on the rotational axis and passing through center points of the plurality of bolts intersects the holding hole.
